(19) United States
(12) Patent Application Publication
(10) Pub. No.: US 2024/0420129 A1
(43) Pub. Date: Dec. 19, 2024

(54) CHAT APPLICATION NFT TRANSACTIONS

(71) Applicant: Datacurve, Inc., Los Altos, CA (US)

(72) Inventors: Rakesh Ramde, Los Altos, CA (US); Amanjyot Singh Johar, Sunnyvale, CA (US)

(73) Assignee: Datacurve, Inc., Los Altos, CA (US)

(21) Appl. No.: 18/669,042

(22) Filed: May 20, 2024

Related U.S. Application Data
(60) Provisional application No. 63/467,693, filed on May 19, 2023.

(51) Int. Cl. G06Q 20/38; G06Q 20/36

(52) U.S. Cl. CPC G06Q 20/389; G06Q 20/36; G06Q 20/3829

(57) ABSTRACT

A retailer initiates a transaction or promotion by sending an offer to a consumer over a chat application. The consumer completes the transaction by accepting the offer in actuating a digital button or otherwise on a computing device or terminal. A digital wallet is generated and the transaction is recorded in an NFT.

### CROSS-REFERENCE TO RELATED APPLICATIONS

The invention claims priority under 35 USC 119 (e) to 63/467,693, entitled CHAT APPLICATION NFT TRANSACTIONS, and filed May 19, 2023, by Ramde et al., the contents of which are hereby incorporated in its entirety.

### FIELD OF THE INVENTION

The invention relates generally to computer networks, and more specifically, conducting consumer transactions using NFTs over existing chat applications.

### BACKGROUND

Many retailers are introducing instant messaging as a means of communication with their customers. Some of these instant messaging channels also provide interfaces for e-commerce. Many of these channels work well as in-app messaging tools that enable sellers to chat directly with their potential customers. However, the user experience within these apps today is typically informational only and not easily used for transactions.

As mobile commerce gains more popularity, especially amongst the new generation of users, shopping will be increasingly intertwined with customer experience. While using standalone chat applications such as WhatsApp or Telegram etc. or built in chat applications on commerce platforms such as Amazon or Walmart, not having transactional capabilities as part of the customer experience will be detrimental for businesses. Today, most chat applications redirect users to a mobile application or a web application to complete the transactions by providing them with a URL link. This is inefficient as the business hands over a customer to another application and the customer may simply drop off and never complete the transaction. For example, today it is impossible for a shopper to buy a physical product inside a chat application, much rather a digital representation of it. It is also impossible for a shopper to buy a digital product and have its physical counterpart shipped to a physical home or office address by virtue of the same transaction.

Therefore, what is needed is a more reliable approach for conducting consumer transactions over existing chat applications.

### SUMMARY

To meet the above-described needs, methods, computer program products, and systems for conducting consumer transactions over existing chat applications.

In one embodiment, a retailer initiates a transaction by sending an offer to a consumer over a chat application, the consumer completes the transaction by accepting the offer in actuating a digital button or otherwise. A digital wallet is generated in the background without the user without burdening the users with the intricacies of registering or setting up a wallet, how to manage private keys or how to interact with the blockchains. The transaction is recorded as an NFT.

In one embodiment, the data may include the customer's name, organization, loyalty information, or any other information regarding their status with a seller or retailer. In addition to a user wallet, the system may also create a decentralized identity for the users. This decentralized identity can further be associated with the user's external accounts such as a retailer loyalty rewards program or a social network, or any other third-party services needed to connect for verification or identity management purposes.

In one embodiment, the system is governed by configurable smart contracts. It is envisioned that the commerce ecosystem comprising sellers, buyers, third party sellers or additional service providers such as insurance, etc. are all incentivized to transact within a customized application such as the chat application. It may be desirable from a business and convenience perspective that the digital assets may only be traded and governed by the rules in the smart contract(s). In one embodiment, the digital assets may be blocked from trading on any third-party systems, exchanges, protocols etc., thereby making it a singular registry of buyer and seller data and digital assets related to the retailers and marketplaces.

Advantageously, retailers can reach consumers for reliable and verifiable transactions over existing chat app infrastructures. It is further desirable to assist retailers, enterprises or any party to surface actionable data or work flows to provide or offer products and services personalized on the basis of the user or chat.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a system to conduct consumer transactions using NFT over existing chat applications, according to an embodiment.

FIG. 2 is a more detailed block diagram illustrating an NFT engine of the system of FIG. 1, according to an embodiment.

FIG. 3 illustrates an exemplary high level architectural view of a sports NFT marketplace and applications, according to an embodiment.

FIG. 4 is a block diagram illustrating the elements of the LogicWare with artificial intelligence, blockchain and Web3 interfaces, according to an embodiment.

FIG. 5 illustrates the use of verified credentials (VCs) for authentication into the ecosystem of applications for access control or user onboarding features, according to an embodiment.

FIG. 6 is a more detailed block diagram illustrating a sports player scouting module of the system of FIG. 1, according to an embodiment.

FIG. 7 is a high-level flow diagram illustrating a method for conducting consumer transactions using NFT over existing chat applications, according to one embodiment.

FIG. 8 is a more detailed flow diagram illustrating an alternative method for conducting consumer transactions using NFT over existing chat applications, according to one embodiment

FIG. 9 is a block diagram illustrating an example computing device for the system of FIG. 1, according to one embodiment.

### DETAILED DESCRIPTION

Methods, computer program products, and systems for conducting NFT transactions over chat applications with location-based event-triggered cryptographic tokens for gated access to location-based (or position-based). One of ordinary skill in the art will recognize many alternative embodiments that are not explicitly listed based on the following disclosure.

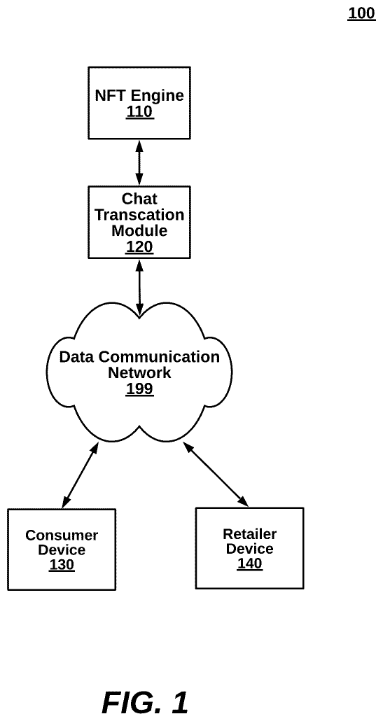

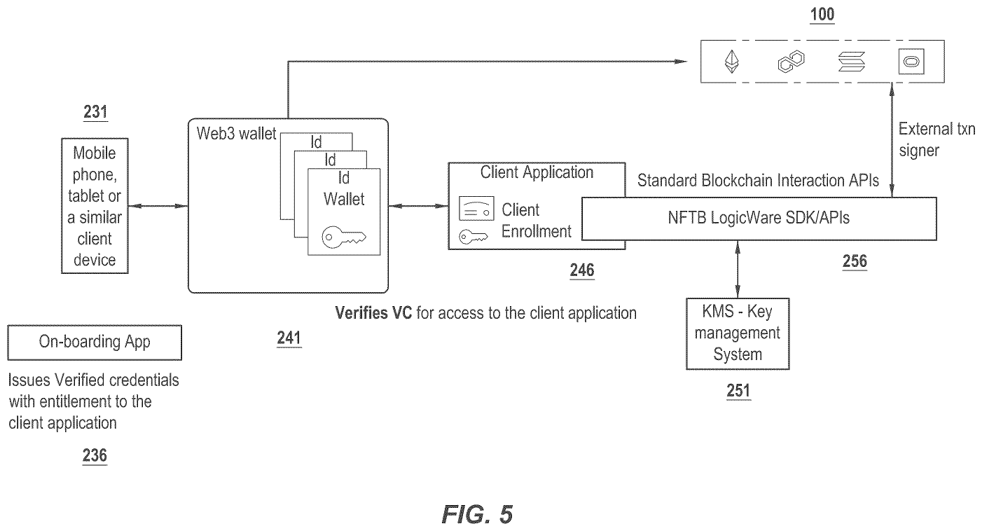

### I. Systems for Chat App NFT Transactions (FIGS. 1-6)

FIG. 1 is a high-level block diagram illustrating a system 100 for conducting NFT transactions over chat applications, according to one embodiment. The system 100 includes an NFT engine 110, a chat transaction module 120 interacting over a data communication network 199 with a consumer device 130 and a retailer device 140, as users of the system 100. In one embodiment, the NFT engine 110 and the chat transaction module 120 are integrated into a single physical device, and in another embodiment, communicate across the data communication network 199. Many other variations are possible.

In one embodiment, the NFT engine 110 mints and allocates tokens based on location-triggered events (and other triggers such as user profiles or user activity) and providing access to token-gated content, in response to a user satisfying specified token criteria. The NFTs can also be minted in accordance with other operational or marketing objectives—for example, as part of a user profile and the user's interaction within the chat application, such as an NFT can be minted when the user joins the chat application. In another embodiment, an NFT can be minted if the user is a member of a group in the chat application. In yet another embodiment, the NFT can be minted if the user is a member of a DAO (decentralized autonomous organization). The backend of the NFT engine is capable of supporting multiple applications and blockchain protocols simultaneously, while each application may be deployed by a unique customer. The NFT engine 110 creates a mapping of the backend databases which may include user information (such as personal information, account information, content and activity data, transactional information, compliance data, behavioral data, demographic data), digital assets, and the blockchain layer interaction to provide a simple workflow for businesses and enterprises. Other ways of minting the tokens include but are not limited to:
a. Embedding chat applications into other applications such as games. Users can be rewarded by participating and interacting with other people or players within the application.
b. Including chat applications as part of a productivity suite of software or an email client or any other collaborative software. The NFTs can be minted in accordance with corporate policies on rewarding their employees or customers.
c. Incorporating chat applications as part of a retail, ecommerce, or any other web application. The NFTs can then be minted in accordance with a loyalty program of the platform, or for any other marketing, tracking, or operational objectives.
d. For a standalone chat application such as Telegram or WhatsApp, the NFT minting can be based on the user's credentials (phone number or email address)
   The NFTs can also be minted in accordance with other operational or marketing objectives, for example as part of a customer or voting experience, or as a membership in a DAO (decentralized autonomous organization). In one embodiment, a telecom company can provide NFT incentives via chat or text messaging that can help reduce churn of users from the network. For events and concerts, for example, if fan voting is to be restricted to fans inside the chat application, the location triggered module can optionally be integrated into chat or text messaging. Other ways of minting the tokens include but are not limited to
a. promotional NFTs and other digital assets for an event such as a pre-sales event prior to the event as a token gated sale;
b. live NFT drops during the duration of an event such as a sale event that may optionally be tied to other activities in a physical retail location while on a chat application;
c. Post-event engagement. NFTs can be created by the users or fans themselves as user generated content, or they may be created from the official content from the events;
d. Promotional NFTs for in between events that can optionally be integrated with loyalty programs to encourage fan reengagement and reward them with digital assets for their loyalty and engagement;
e. Auctions: The platform can put a specific item up for auction, with the highest bidder being awarded an NFT in a chat application. This can be particularly effective for rare or one-of-a-kind items;
f. Collaborations: A collaborative NFT may involve chat-based communications with other brands, artists, or creators to create unique NFTs that combine their styles or content. These can also be sponsored by some advertisers wishing to reach a particular demographic, based on their data and behavioral patterns.

The NFT platform described herein takes the complexity of the blockchain environment and abstracts it into a set of APIs and SDKs that can manage the entire process easily. For example, crypto wallets are front end technologies that require user interaction and input to mint an NFT from a smart contract. The NFT engine is configured to be a backend and middleware technology managing the complexity away from the user and providing for interaction via APIs and SDKs. As such any frontend application can now interact with the blockchain burdening the users with the intricacies of storing or managing their private keys and authorizing transactions to sign transactions to interact with the blockchains and mint, redeem, or create NFTs. A proxy process can be deployed in the backend that abstracts the user signatures as part of the transaction. At the backend, the transactions can also be handled by custodial wallets, or multi-signature wallets that can associate the transactions to the user accounts. The backend is capable of supporting multiple applications simultaneously and while each application may be deployed by a unique customer. The NFT engine 110 maps the backend databases, digital assets, and the blockchain layer interaction to provide a simple workflow for businesses and enterprises.

Fungible cryptographic tokens are known. For example, one type of fungible token format is the well-known ERC-20 token. Non-fungible cryptographic tokens (NFTs) are known. For example, one type of NFT format is an ERC-721 token. Both are operable with an Ethereum virtual machine (EVM). While the token formats are known, each token can be configured to create unique functionality, unique expressions, or other unique aspects of the token. An NFT is a cryptographic token that represents ownership or other rights of a designated asset, e.g., a digital file or other assets associated with the token. Typically, the digital file or other asset is referenced in metadata in the token definition.

Token creation (e.g., minting) and transactions are typically handled via “smart contracts” and a blockchain (e.g., the Ethereum blockchain) or other distributed ledger technology. NFTs are minted according to known token minting protocols, but each can be configured with their own parameters to create uniqueness between the tokens. With some tokens, the token may be minted on demand when the token creator decides to mint the token. Some fungible tokens are minted and initially allocated via an initial coin offering. Some tokens are “pre-mined” and subsequently allocated or offered for sale. For example, once minted, an NFT can be offered for sale or acquisition via an NFT marketplace or other token sale/distribution platform.

The existing token minting and sale process suffers from various technical drawbacks and limitations. For example, conventional “smart contracts” have numerous advantages but are limited in that typically they can operate only on the data contained inside the nodes of the blockchain on which they run. This makes them like a self-contained system, somewhat closed to external sources. This can be problematic when external data is needed to satisfy conditions or functions of the smart contract.

By using a blockchain-based system and specifically NFTs within standalone chat applications such as WhatsApp, or Telegram etc. or chat applications embedded into websites such as Amazon or Walmart etc., the customer experience could be significantly enhanced. Businesses and brands of all sizes can easily engage with their users via NFTs that can represent giveaways, loyalty rewards, gifts, coupons, vouchers, etc. as needed. The decentralized nature of blockchain could also make it more difficult for unauthorized individuals to access or tamper with such NFT based utilities. Moreover, blockchain-based resource and communication tools could facilitate data sharing between various departments of the business, such as customer service, marketing, and operations. It can also facilitate data sharing between a business and its partners for example, between Walmart and its suppliers. Additionally, the use of smart contracts on a blockchain could potentially automate various aspects of the customer experience and customer success programs deployed widely in organizations. Finally, the use of NFTs incentivizes the holders of the NFTs with recognition and rewards while reinforcing positive behaviors, skills or outcomes for natural communities of said businesses, organizations, suppliers, users, and other ecosystem participants, who could all benefit from sharing data in a unique manner.

As retailers seek to create more engagement and create novel experiences for their users, chat applications may serve as a medium for them to directly engage with the users one-on-one and personalize user experiences. As such adding transactional capabilities is desirable, specifically as it relates to transacting in digital assets or NFTs. These digital assets can represent a variety of experiences from coupon codes, to loyalty rewards, to gift vouchers, a digital avatar, or a set of stickers, a survey, or simply a recognition of a transaction itself.

It may be noted that the LogicWare also provides for creating wallets with various ways of protecting the private keys. The private keys can be stored on a Hardware Security Module (HSM), or in Key Management Systems (KMS), whose keys may be further entrusted to an encrypted vault. The keys can also be managed using a multi-party computation (MPC) process that enables multiple parties to jointly compute a function without revealing their private inputs to each other. As part of the key management contemplated by this invention, LogicWare can distribute the private key across multiple parties in a way that ensures that no single party has access to the full private key. Instead, each party holds a share of the private key, and only by combining all shares can the full private key be reconstructed. Finally, irrespective of the key security mechanism described above, if at any time, a holder of the private key so desires, they can take complete control of their private keys via LogicWare.

For users of such a system, it is important that the system should be easy to use and provide for secure authentication. It is also important that the system not allow for deconstruction of personal identities based on chat messages or records of business conversations with businesses within the chat application. As such, authentication plays an important role. An authentication module can optionally store login information and authenticate users against the blockchain information. As detailed below, the system can deploy decentralized IDs to enable selective disclosure of information or identity attributes. A user's public key may be stored on the blockchain which allows anyone to verify the authenticity of messages, transactions, or other data associated with that identity. A user in the ecosystem (customer, brand, venue, league, retailer, etc.) may store identity-related data on the blockchain, such as verifiable claims, which are claims that have been cryptographically signed by them and can be verified by others without revealing any additional information about the identity. Also, Zero knowledge proofs can be implemented to ensure that information about a user can be verified without sharing any personally identifiable information or protected information. Finally, verified credentials can also be deployed to ensure trustworthiness of the system.

A verified credential as part of this invention is a digital representation of a piece of identity-related data that has been cryptographically signed by a trusted authority. These credentials can include things like a person's name, date of birth, address, credit card details, historical purchases etc. or any other information as defined above relevant to a business application for customer interaction or immersion. In a DID system, verified credentials are used to help establish trust between different parties. For example, when a user wants to prove their identity to a service provider (retailer, data aggregator, loyalty program provider, etc.), they can present a verified credential that has been issued by a trusted authority such as insurance company, a government agency or any other trusted participant in the ecosystem. The service provider can then cryptographically verify the authenticity of the credential without having to rely on a centralized identity provider. These verified credentials can be stored on the blockchain, along with the decentralized identity and associated public keys. This allows them to be accessed and verified by anyone in the network without the need for a centralized intermediary. Additionally, because the credentials are cryptographically signed, they cannot be tampered with or altered without detection. Overall, verified credentials help to provide a more secure, private, and flexible approach to identity management, enabling individuals and organizations to assert and control their identities without relying on centralized intermediaries.

The NFT engine 110 offers a wide range of features, including a) location information is available from the device; b) users can log into various applications such as text, audio, or video chat applications like Telegram, WhatsApp, Messenger, Clubhouse, or any embedded chat app within a website or a native mobile app. Additionally, they can access 3D metaverse applications powered by gaming engines such as Unity or Unreal Engine, among others; and c) a geofence can be configured around retail venues, conference halls, convention centers, airports, stadiums, or arenas. This ensures that only participants within a specific physical location can interact with the system and access the benefits described herein.

When location is enabled, users entering the geofenced area can interact with an application. The LogicWare, along with APIs and SDKs, allows the chat application to be developed as a single web app, a native mobile app, a monolithic client application, or with various features split between the client and server ends of the application, with separate roles for users and admins.

The application can be triggered in several ways, including scanning a QR code, accessing a specific URL displayed by the venue, being automatically configured in the backend and presented to the user as part of another application, or sent to the user as an SMS or message. Single sign-on (SSO) or a SAML assertion within an application is also supported.

The application allows users to register or initiate in multiple ways, such as logging in with email, any social network, single sign-on, or a SAML assertion. Users can associate their login details with a wallet address on a blockchain (a public key) and store a corresponding private key. Additionally, the application can optionally create a decentralized identity wallet for the user, with verified credentials mapped to the user's biometric information. These verified credentials allow anyone to ascertain whether the decentralized identity is associated with a user, without knowing any other personal information about the user.

Users can claim a digital asset by presenting the public key to the application configured with a smart contract. The asset can be redeemed through various means, including payment by fiat, payment by crypto, redeeming a code, allowing whitelisted wallet addresses to mint an asset, or blocking blacklisted wallet addresses from interacting with the application. Note that the private key is optional to redeem the asset, and the system can create carbon credits using the system private keys or with multi-sig techniques.

The application is governed by smart contracts, which can be EVM compatible or run on other public blockchains such as Solana, Near, Aptos, or rollup blockchains like Optimism, or private blockchains such as Hyperledger. Smart contracts could be pre-configured within or outside the application, or they could be deployed from within the application for customization.

Smart contracts allow for various types of digital assets, including unique digital assets (ERC 721) or their equivalents on non-EVM blockchains, copies of unique digital assets (ERC 1155) or their equivalents, mix and match of various other digital assets (ERC998) or their equivalents, semi-fungible tokens (ERC3525) or their equivalents, and the rental of digital assets. Assets created via the smart contract can be imported within a metaverse environment or a 3D environment powered by any gaming engine.

Optionally, the application may allow for smart contract deployment on the fly, creating a private key/wallet address pair for deployment of the smart contract, known as a deployment wallet. This wallet does not hold any digital assets (NFTs) but may hold cryptocurrencies and can pay for transactions related to the digital assets created via the smart contract. Transactions may also be paid by an eventual buyer of the digital assets. Smart contracts can be automatically configured and deployed via API calls, on demand in real-time, and on a choice of blockchains or test network environments.

Digital assets created and stored may include creative elements such as pictures, audio, or video content, along with associated data related to the business, user, affiliates, or ecosystem partner for whose benefit the NFT may be created. All data and metadata can be stored centrally on any internet-connected server or in a decentralized manner using protocols such as IPFS or Arweave, among others. Digital assets may or may not be transferable to any other wallet address on the blockchain, and payments are processed by storing the confirmation ID and token ID as proof of payment on the blockchain when the token is minted.

In one embodiment, the NFT can be issued within one geofenced location and redeemed for a transaction in another geofenced location, with additional rules or user requirements overlaid or in addition to geofencing rules.

The NFT engine 110, in an embodiment, mints and allocates cryptographic experiential tokens based on a location-based event or based on the triggers and conditions described above and entitling the user to access an experience, for instance. In another aspect, token-gated access is granted to a resource at a location based on location triggered events and providing access to token-gated content in response to a user satisfying specified token criteria.

The system 100 may employ computer code modules (e.g., smart contracts) configured to manage the assignment of the non-fungible cryptographic tokens to designated digital wallet addresses associated with corresponding owners of the non-fungible cryptographic tokens. Digital wallets, or e-wallets or cryptocurrency wallets, can be in the form of physical devices such as smart phones or other electronic devices executing an application or electronic services, online services, or software platforms. Devices serving as digital wallets may include location-based services capabilities, e.g., GPS, UWB, BLE, WiFi, NFC, and other capabilities. Digital wallets may provide a store of value or a credit or access to credit and may be in the form of a digital currency or involve a conversion to digital currency, tradeable digital asset, or other medium of exchange. The stored value accessible using a digital wallet may involve authentication to access ownership records or other indica stored in a digital ledger or DLT and requiring authentication and/or other decryption techniques to access the store of value. Parties may use digital wallets in conducting electronic financial transactions including exchanges of digital currency for goods and/or services or other considerations or items of value. Transactions may involve use of merchant or other terminal equipment and involve near field communication (NFC) features or other communication techniques and use a computer network. In addition, digital wallets may include identifying or authenticating information such as account credentials, loyalty card/account data, and driver's license information, and the transaction may involve communicating information contained or stored in the digital wallet necessary to complete intended transactions. As such, it is advantageous to create a decentralized identity for the user, so that their personal identity is secure and protected and that their privacy is not subject to unnecessary public scrutiny.

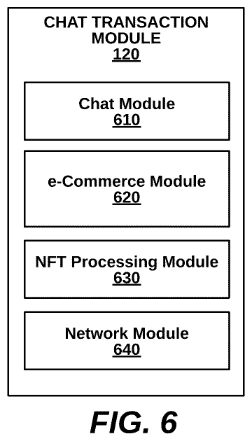

FIG. 6 is a more detailed block diagram illustrating a sports player scouting module of the system 100 of FIG. 1, according to an embodiment. The chat transaction module 120, of this embodiment, includes a chat module 610, an e-commerce module 620, an NFT processing module 630 and a network module 640. The chat module 310 uses one or more chat apps to communicate with consumers and retailers through the consumer device 130 and the retailer device 140, such as WhatsApp, Facebook Messenger, Instagram messenger, TikTok messenger, or any other independent or integrated messaging application. The e-commerce module 620 interfaces transactions between consumers and retailers. The NFT processing module 630 interoperates with the NFT engine 110 as a back end using APIs and other communication techniques to record transactions. The network module 640 uses communication channels such as Wi-Fi, Ethernet or cellular to send and receive transaction data and other data. Additionally, AI agents can be used to facilitate automated data reporting service processes that may interact with one or more modules 610-640.

AI agents can be used to facilitate automated data reporting service processes that may interact with the NFT processing module 620 automatically. Such automated data reporting service processes may include:

1. Database services designed to manage, query, and report data from relational, non-relational, or vectorized databases efficiently.

2. Business intelligence tools that collect and process large amounts of unstructured data from internal and external systems, prepare it for analysis, develop queries against that data, and create reports, dashboards, and data visualizations.

3. Data Warehousing Solutions that aggregate data from multiple sources, making it easier to provide comprehensive reporting and analysis. They often include tools for automated reporting and data analysis.

4. AI powered analytics platforms that use artificial intelligence to analyze data and generate reports. They can identify patterns, trends, and anomalies without human intervention.

5. AI agents that meet specific business needs, capable of extracting data from various sources, analyzing it using machine learning models, and generating tailored reports. These agents can be trained to provide insights specific to the business's operational, tactical, or strategic queries.

These automated data processing reporting services may also include spreadsheet tools with automation features, API based tools, cloud-based reporting services, ETL (extract, transform, load) tools or any combination of the above to surface actionable opportunities and data.

The chat transaction module 120 allows a user to scan a QR code from within the chat application via the camera of a mobile device or tap an NFC code, for example. The QR code (or NFC tap) may be pre-configured with information about the user including but not limited to their public wallet address. The QR code may also be pre-configured to open a URL on a browser or run a script within the chat application itself. In either case, prompts can be shown to the user to redeem an NFT. The smart contracts deployed, in an embodiment, can also check and verify whether the said wallet address is on a whitelist of addresses that is allowed to mint or redeem an NFT. If the address is whitelisted, the user can mint the NFT, whereas if not, an error message can be shown. In other embodiments, the wallet address can be derived via a user's email address, phone number, or biometric information, or any other information that can be uniquely attributed to the user.

To deliver NFTs through a chat app, users can first set up a crypto wallet. The platform can allow users and consumers to create a crypto wallet on the fly and use it for receiving and sending NFTs from the brands or companies. Users need not set up a separate wallet per channel in the chat application since one universal wallet for the entire application can suffice. Alternately, users may wish to set up a separate wallet for interacting with each brand. This wallet will hold the user's NFTs and allow them to manage their balance and make transactions. Once the wallet is set up, users can then send and receive NFTs through the chat application. Redeeming an NFT can be easily accomplished by clicking on a “Redeem” button within the chat application, provided by the brand. The redeem button might look innocuous, but it embodies a number of innovations behind the scenes. For one, the redemption involves the steps outlined above with the platform-including, deploying smart contracts on a blockchain layer, and managing the mint and/or transfer functions for the NFTs. The NFTs themselves can be based on ERC721, 1155, 998 (composable NFTs), or 4907 (NFT rentals), 4337 (gasless minting), 6551 (tokenbound accounts), or any other standards that may be developed or deployed. NFT standards could also be on any blockchain including but not limited to Ethereum, Polygon, Solana, Base etc. NFTs are uploaded onto the platform or generated from images, audio, video, or any other digital data format including AR/VR/3D modeling etc. It may be noted that each of these NFTs is further associated with metadata and wallet address of the users prior to or simultaneously with the NFT mint or transfer transaction. It is further noted that the metadata may be provided via an interaction with automated data reporting service processes such as AI agents. Some transactions or services could be based on what NFTs a user may have in or reveal from their wallet and then link or redeem one or more NFTs (or coupons, or other discounts such as frequent user accounts) for a product or service. Accordingly, the NFTB platform 110 provides all the tools and resources to integrate with the chat application.

The use of chat apps for delivering NFTs has several benefits. One of the main advantages is the convenience it offers. Users can send and receive tokens instantly, without having to go through the process of integrating and setting up a separate wallet or exchanging the NFTs on a third-party platform. This makes it easy for users to quickly and securely transfer tokens within their network of contacts.

Another advantage of using chat apps for delivering NFTs is the increased security it offers. Most chat apps employ end-to-end encryption, which ensures that only the sender and recipient can access the content of the message. This means that the tokens are safe from potential hackers or other malicious actors who might try to steal them. In addition, the use of chat apps for delivering NFTs can also help to increase the adoption of NFTs. By making it easy for users to send and receive tokens through a familiar and user-friendly platform, chat apps can help to promote the use of NFTs amongst a wider audience. Overall, the use of chat apps for delivering NFTs is a convenient and secure way for users to manage and transfer their digital assets. By offering increased convenience and security, chat apps can help to promote the adoption of digital assets and drive the growth for a new market.

Still another advantage of using wallet addresses is that the identity of users can remain anonymous. As such, a user's transactions and interaction need only be mediated by their wallet address and no other personally identifiable information. This provides users with enhanced privacy. This also turns modern advertising on its head. Today, advertisers target people based on their demographic data. Instead, with NFTs, advertisers can target users based on the metadata of one or more NFTs that may be affiliated to a wallet address. This metadata can be public or private and many correlations can be created amongst the metadata information, all without using any demographic or identity information about the users themselves. Advertisers can drop offers, discounts, collectibles etc. to users right within the chat application channels. Furthermore, if the users wish to redeem the NFT based offers, their NFTs can be burned and will no longer be registered to their wallet addresses. This helps avoid the problem of spam content or offers in the digital wallets-something that is a bane for email marketers. If certain offers are not redeemed, the NFT can also self-destruct, without the user's involvement.

As a further benefit, automated data reporting service processes such as AI agents can create necessary reports, analytics, and actions that may provide business, marketing or any other benefits, including aggregating information from the physical and virtual locations where such data and experiences are stored or delivered.

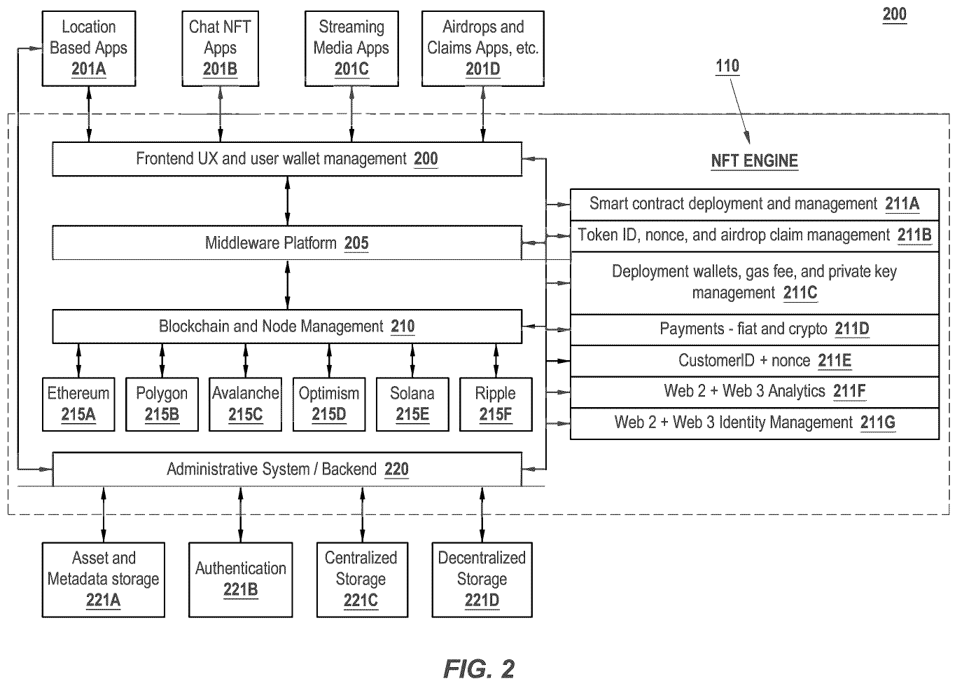

FIG. 2 illustrates one embodiment of a high-level architecture 200 and incorporates the NFT engine 100 with components 211A-G. Various other components and modules can be added to the NFT Engine to accommodate customized NFT requirements.

The NFT Engine 100 interfaces with a variety of other software modules including the user experience modules and the core software infrastructure modules. In one embodiment, 201A is a location-based application that is built using the NFT Engine 100. Location based apps 201A could also be a non location-based application or any other generic application that provides blockchain and NFT functionality to the users. Chat NFT apps 201B is another application or module interacting with the NFT engine 100. Other applications from a user experience perspective may be streaming media or digital avatar apps such as 201C or AirDrop and claims applications such as 201D. There may be many more applications that can be built on top of the NFT engine. These applications interface directly with a chat application and NFT engine via the front end UX and user wallet management modules 202. In addition these applications also interface with an administrative system or a backend, 220, which may be specific or customized for each application. The front end UX and user wallet management module 202 is connected to the NFT brewery middleware platform, 205, which in turn connects to blockchain and node management modules 210. It may be noted that all the components of the NFT engine may also be directly interconnected with each other to ensure proper data flow, data and identity management and access controls for the users. The administrative system or backend 220 connects to various blockchains including but not limited to Ethereum 215A, Polygon 215B, Avalanche 215C, Optimism 215D, Solana 215E, Ripple 215F, or any other EVM or non-EVM blockchain via custom RPCs and APIs. In addition the back end 220 provides support for asset and metadata storage 221A, authentication 221B, centralized storage 221C, or decentralized storage 221D. Other modules and components of the NFT engine include:

1. Smart contract deployment and management module 211A, that supports any underlying blockchain

2. TokenID, nonce, airdrop claim management modules 211B to ensure individual transactions can be processed out of sequence as well in case certain transactions are held up in the execution queue.

3. Deployment wallets and scripts, wallet management including private key management and gas management 211C, with a variety of ways for managing private keys including encryption, utilizing key vaults, multi-party computation techniques (MPC) or multi-signature wallet management.

4. Payments modules for both fiat as well as cryptocurrencies 211D via payment gateways, integrating recording the transaction results and status directly into the blockchain.

5. CustomerID and Nonce management for individual customers 211E, similar to the user side described above, to ensure that transactions by different customers do not queue up and can be processed independently.

6. Integrated web2 and web3 analytics (211F) to map transactional information of users to their wallets. In addition, AI techniques and algorithms can be utilized to infer behavioral information about users independent of their demographic information.

7. Integrated web2 and web3 identity management (211G) that allows for access controls to be implemented based on the digital wallets, ownership of media or avatars, or any other digital goods or identity modules including SSO, SAML, etc.

The NFT engine 100 mints and allocates cryptographic experiential tokens entitling the user to access an information stored in the blockchain. In another aspect, token-gated access is granted to a resource providing access to token-gated content in response to a user satisfying specified token criteria.

Web3 represents a shift towards a more decentralized, transparent, and user-centric internet, where individuals have greater control over their online interactions and data. Web3 refers to a next generation of the internet, where decentralized networks, blockchain technology, and cryptocurrencies are integrated to create a more open, secure, and user-centric internet. Unlike Web 2.0, which is characterized by centralized platforms and services controlled by large corporations, Web3 aims to decentralize the internet, giving users more control over their data and online interactions.

In Web3, users interact with decentralized applications (dApps) that run on blockchain networks, such as Ethereum, and communicate through peer-to-peer protocols. This enables trustless transactions, where intermediaries are eliminated, and transparency is ensured through the immutability of blockchain technology. One of the key features of Web3 is the use of smart contracts.

Smart contracts are self-executing contracts with the terms of the agreement directly written into code. Smart contracts enable automated and tamper-proof agreements, facilitating various applications such as decentralized finance (DeFi), non-fungible tokens (NFTs), and decentralized exchanges (DEXs).

Immutable refers to the inability to modify or tamper with data once it has been recorded. Transactions and data recorded on a blockchain are immutable, which means that they cannot be altered or deleted retroactively. This immutability is achieved through cryptographic hashing and the decentralized consensus mechanisms employed by blockchain networks. The immutable nature of blockchains ensures data integrity, transparency, and an auditable trail of all activities, which is crucial for applications requiring tamper-resistant record-keeping and trustless interactions. Data can also be stored immutably over the InterPlanetary File System (IPFS), which uses content-addressing to store immutable data in a distributed file system. This complements the immutable data storage capabilities of blockchains. Data can be stored on IPFS instead of directly on a blockchain due to the significant storage constraints and costs associated with recording large amounts of data on most blockchain networks. By storing the data immutably on IPFS and recording just the content-addressed IPFS hash on the blockchain, applications can leverage the immutability and tamper-resistance of both systems while optimizing for efficient data storage.

Ingesting data is the process of importing assorted data files from one or more sources into a cloud-based or on-premise storage medium, a data warehouse, data mart, InterPlanetary File System (IPFS), decentralized storage network, or any other structured or unstructured database where it can be accessed and analyzed. This process involves extracting data from various sources, transforming it into a compatible format, and loading it into the designated storage or a processing system. Efficient data ingestion mechanisms are crucial for handling large volumes of data from multiple sources in real-time or batch modes. The ingested data can encompass various formats, including text, numerical data, audio, video, and multimedia content. The ingested data can originate from databases, log files, IoT devices, social media platforms, or any other data-generating source, enabling organizations to consolidate and derive insights from diverse data sets. Robust data ingestion pipelines ensure data integrity, scalability, and integration with downstream analytics and processing systems.

A backpack is a cryptographic construct that binds a user's digital identity, data, credentials, or any other digital assets to a non-fungible token (NFT) or other blockchain-based token. This account backpack NFT serves as a secure, portable representation of the user's identity, data, credentials, and other assets across different applications. By leveraging the immutability and trustless characteristics of blockchain technology, the account backpack provides users with self-sovereign control and management of their digital identity and assets within a unified repository while maintaining security, transparency, and an auditable record of account activity.

Binding refers to the cryptographic process of associating a user's digital identity, credentials, assets, or data with a specific blockchain token or non-fungible token (NFT). This binding establishes an inseparable link between the token and the account, ensuring that the account's contents are inextricably tied to the token's ownership and transfer. The binding mechanism leverages cryptographic primitives like digital signatures and hashing to create a secure and verifiable connection between the account data and the fungible or non-fungible tokens. Once bound, the account and its associated data can only be accessed, modified, or transferred by the rightful owner of the corresponding token, as established by the private key/wallet address pair, providing self-sovereign control over the digital assets, identity and credentials.

A series of NFTs may refer to a chronological sequence of recorded activities, actions, or occurrences. Each NET that is created in the series may be appended as an immutable entry, preserving the order and integrity of the overall series. The series of NFTs therefore allows for a transparent and auditable log of all events that have transpired within a system or process. As such, the system ensures a verifiable history that cannot be retroactively modified, enabling trustworthy record-keeping and traceability of operational activities over time.

An interval represents a specific, finite period or window of time that is consumed or utilized in its entirety. An interval has a defined start and end point. Once an interval has been allocated or assigned for a particular purpose, it cannot be reused or reassigned until it has been fully consumed or expired. This property of intervals ensures exclusivity and prevents overlapping usage conflicts within the designated time window. For example, if data from a particular interval has been converted to an NFT for audit purposes, the same data may not be included in another interval for a second NFT, as it may lead to double counting of the resources utilized in the interval. Such double counting can lead to conflicts and destroy the integrity of the data.

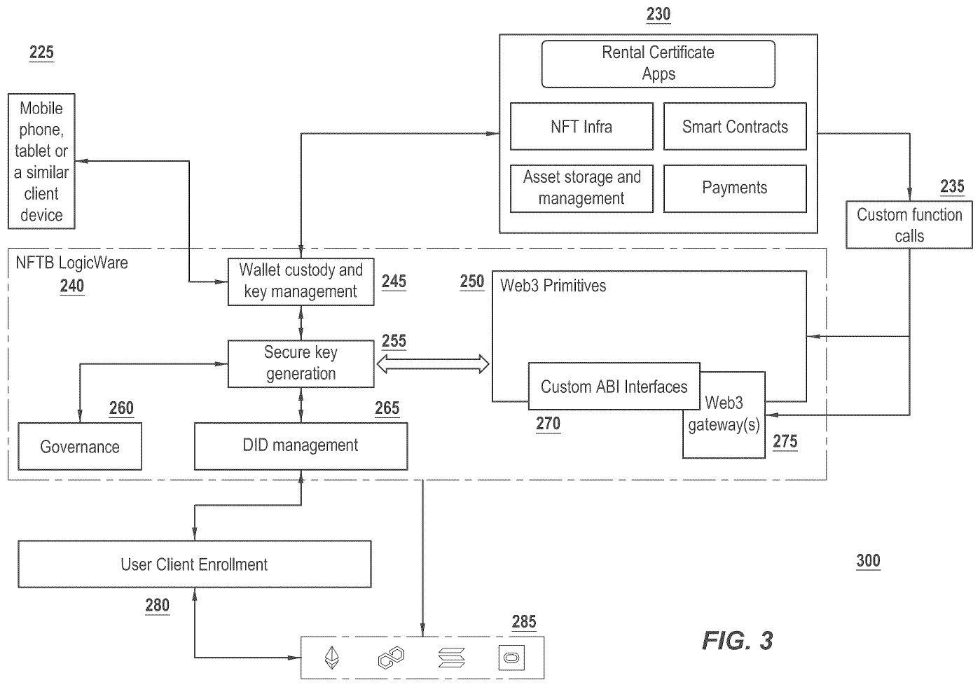

FIG. 3 illustrates an exemplary high level architectural view of a wallet creation system for chat embedded with customer support applications that can communicate with a mobile phone or other client device. Various other components and modules can be added to this architecture to accommodate customized NFT requirements.

The end user may log in into the platform using a mobile phone tablet or similar client device 225. The application running on the device interacts with the NFT middleware platform via the NFTB LogicWare 240. The LogicWare determines the wallet custody and key management protocol 245 that applies to the particular application 230 or the user and logs the user in into the application. If the user interacts with the application or dApp the first time, the custody and key management protocol 245 generates a new key pair using the secure key generation module 255 or the user and associates it with their identity. Optionally it may also associate the keys with a decentralized identity and issue verified credentials to the user. Additionally, LogicWare also creates or associates the governance policies that the user identity may be subject to. If the user is a returning user, the LogicWare retrieves the keys and based on the governance and access control rights, allows the user to access the application or the dApp. As depicted in FIG. 2 the application or dApp may consist of several components including smart contracts deployed via the module 211A or otherwise imported into the application, NFT infrastructure modules such as 211A, 211B, 211C, 211D, 211E, 211F, 211G, etc., asset storage and management (221A, 221C, 221D), or payments (211D) etc.

The application interfaces with the middleware and NFT engine 240 via custom function calls APIs and SDK's 235. The NFTB LogicWare includes various web3 primitives, 250, that are interoperable building blocks that are highly reliable in executing transactions over a blockchain, communicate with backend 220 and frontend 200 systems, work with storage components 221C, 221D, utilize analytics from modules such as web2 and web3 analytics 211F, identify users using the identity management module 211G, secure the applications using authentication, identity management, or implement access controls with 211G, 211B, etc. or provide for a governance layer in combination with the governance module 260. The web3 primitives 250, also communicate with custom ABI interfaces, 270, and web3 gateways, 275, for deploying smart contracts to their respective blockchains, interacting with smart contracts, and executing the functions and instructions in the smart contracts.

In addition, the LogicWare optionally comprises a governance 260 and a Decentralized Identity (DID) management module 265. DIDs are an important part of securing identity and making it interoperable across both web2 and web3 platforms.

Applications in web3 are also referred to as dApps. Governance in decentralized applications (dApps) in and communities refers to the processes and mechanisms through which decisions are made and actions are taken within the decentralized ecosystem. In traditional centralized systems, governance is typically controlled by a central authority, whereas in decentralized systems, governance is distributed among network participants. In one embodiment, the decision making and governance is in part based on the decentralized identity of the users themselves, who interact with the dApp and the associated smart contracts with their wallets and their corresponding private keys. The private key is a highly confidential key that authorizes transactions on the blockchain, proving ownership of the associated digital assets. The wallet address is the public counterpart, similar to a public address, that serves as a store of digital assets. The Governance module 260 within the NFTB LogicWare allows for implementing various governance mechanisms and resource allocations. In conjunction with the DID management module 265, the governance module 260 also employs mechanisms to prevent Sybil attacks or other malicious attacks on the system, such as, where an individual may create multiple identities to gain disproportionate influence for voting purposes. Sybil resistance mechanisms can include reputation systems, stake-weighted voting, or identity verification to ensure that governance decisions are made by genuine participants.

The DID management module (265) is a part of the web2 and web3 identity management module (211G) described above. The module utilizes methods for decentralized technologies, such as distributed ledgers (e.g., blockchain) or peer-to-peer networks, to enable the creation, management, and verification of DIDs and associated digital identities. As such, the DID created for any user can be used as an identity across any blockchain and helps identify the user on the application, without compromising the user's actual identity or demographic information. The users retain full control over their DID and can choose to lock and selectively share their information using their DIDs. In particular, this is an efficient way of combining various private blockchain systems favored by enterprises, with the public blockchain systems. With a DID, a user can retain the same wallet address to make transactions over any supported blockchain.

Various blockchains may have different ways to monitor and govern the identity of the users. In order to map the identity from one system to another, it may be necessary to homogenize the identity across the multiple platforms by implementing a client enrollment module 280 to create a system where the identities from one system may map directly to an identity on another system, without the need for any user intervention. For example, when making a private blockchain system to be compatible with a public blockchain such as Ethereum, Polygon or Solana, it may be essential to create a user (client) enrolment into the Hyperledger based system and map it to the private keys for the eventual user of the system.

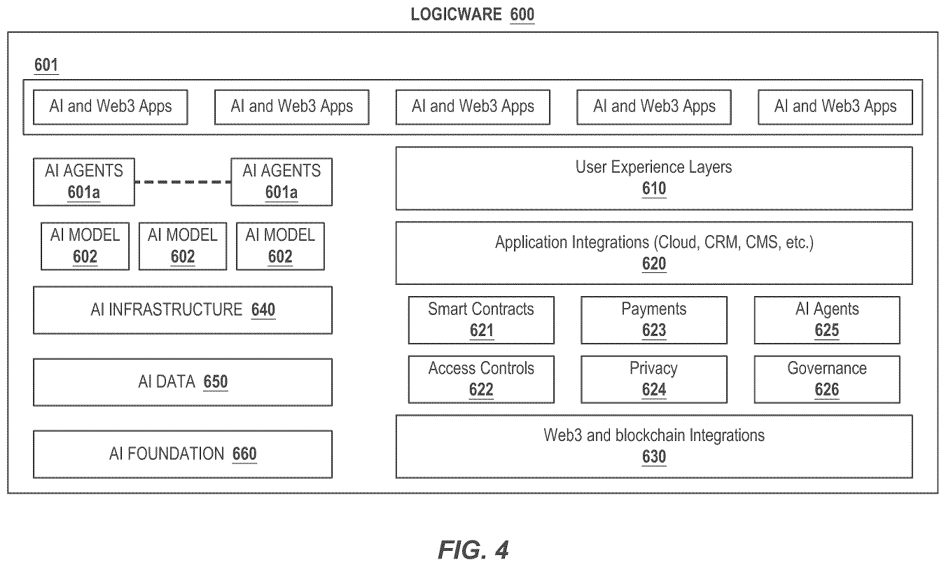

FIG. 4 illustrates the use of verified credentials (VCs) for authentication into the ecosystem of applications for access control or user onboarding features.

When a user logs in to the platform 400 using a mobile phone, tablet, desktop, or a similar device 231 the onboarding application 236 or dApp issues a verified credential (VC) to the user. It may be noted that the VC may be issued by a third-party application separately and imported into the client application. These VCs allow the user to access other connected applications or dApps that the user may wish to, such as loyalty programs, using their decentralized identity. As such verified credentials (VCs) act as an authenticating mechanism for users to use the appropriate wallets as a proxy for their identity on the system. A user may have multiple wallets associated with their identity. When a user logs in to the application or dApp, LogicWare 256 identifies the appropriate identity to use and retrieves the appropriate keys from the key management system, 251. This in turn allows the application or dApp 246 to transact with the blockchain using the appropriate identity and the private keys associated with them. A user's public key may be stored on the blockchain which allows anyone to verify the authenticity of messages, transactions, or other data associated with that identity.

### A. Artificial Intelligence for Gathering and Analyzing Renter Data

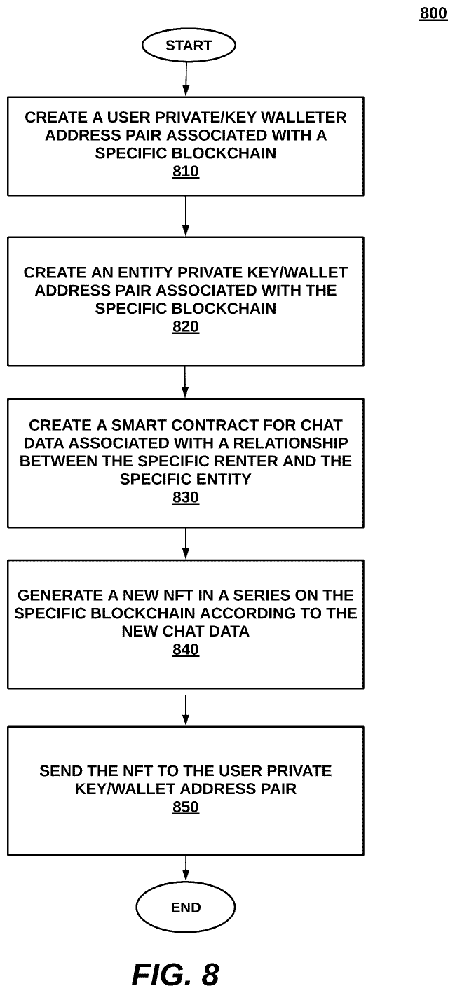

FIG. 4 is a block diagram further illustrating the elements of the LogicWare with AI, AI agents, blockchain and Web3 interfaces. The system depicted in FIG. 8 abstracts away many of the complexities involved in building and operationalizing AI systems, enabling developers and applications to focus on leveraging AI capabilities rather than dealing with low-level infrastructure concerns. AI Foundation 660 refers to the underlying platform enabling the integration and deployment of AI capabilities with LogicWare. The AI Foundation serves as a common layer that provides essential services and components required for developing, deploying, and managing AI models and applications. AI Foundation may be part of the Logicware 110, deployed as SDKs or made available to Logicware via APIs. AI Foundation may include or support the following key elements:

Data ingestion and preprocessing: Components for collecting, cleaning, and preprocessing data from various sources to prepare it for use in AI models.

Model development and training: Tools and environments for building, training, and evaluating AI models 602, such as machine learning, deep learning, or natural language processing models.

Model management: Services for versioning, storing, and managing trained AI models 602, as well as monitoring their performance and updating them as needed.

Inference and deployment: Mechanisms for deploying trained AI models into production environments, allowing applications and systems to consume and leverage the AI capabilities.

Scalability and performance: Infrastructure 640 and services that enable the efficient scaling and high-performance execution of AI workloads, often involving specialized hardware like GPUs or TPUs and cloud-based services.

Security and governance: Mechanisms for ensuring the secure and compliant use of AI models, including access control, auditing, and adherence to regulatory requirements.

Integration and APIs: Interfaces with Application Integrations 630 and APIs that allow other applications and systems to seamlessly integrate and consume the AI capabilities provided by the foundation such as process systems 621-626.

AI Foundation 660 aims to provide a standardized and consistent platform for AI development and deployment with Logicware 110, across the organization, promoting reusability, scalability, and governance of AI solutions. Some of the features of the AI Foundation 660, may also integrate with cloud, CRM, CMS and other systems via Application Integrations 620.

AI Data 650 refers to the information used to train and develop artificial intelligence systems. This data can be in various forms, such as text, images, audio, or numerical data, depending on the application of the AI system. Ensuring the quality, relevance, and diversity of AI data is crucial for building accurate and unbiased AI models. AI data can be both structured and unstructured:

1) Structured data refers to information that is organized and formatted in a predefined way, such as databases, spreadsheets, or labeled datasets. This type of data is typically used for tasks like classification, regression, or structured prediction problems.

2) Unstructured data, on the other hand, refers to information that does not have a predefined format or structure, such as text documents, images, audio files, or social media posts. This type of data requires more preprocessing and feature extraction techniques before it can be used for training AI models.

3) Many AI applications, especially in areas like natural language processing (NLP) and computer vision, rely heavily on unstructured data, while structured data is more commonly used in fields like finance, healthcare, and manufacturing.

Logicware works with both structured and unstructured data which can also be integrated via application integrations 620.

AI infrastructure, 640, refers to the combination of hardware and software resources required to develop, train, and deploy artificial intelligence systems effectively. It includes powerful computing resources, such as GPUS, TPUs, or specialized AI accelerators, to handle the computationally intensive tasks involved in training large AI models. AI infrastructure also encompasses the software platforms, frameworks, and tools used for data preprocessing, model building, training, and inferencing, which may also be a part of the AI Foundation. Additionally, AI Infrastructure 640 may involve storage and data management solutions to handle the vast amounts of data required for AI model training. The system in FIG. 6 enables robust AI infrastructure is crucial for organizations to scale their AI initiatives and achieve efficient model development and deployment cycles.

Automated data reporting service processes such as artificial intelligence agents (or AI agents) are software programs or algorithms designed to perform specific tasks autonomously, making decisions and taking actions based on predefined rules, learning from data, or adapting through machine learning techniques. AI agents can leverage data, including data associated with NFTs, to perform various tasks and processes. AI agents are used in various applications across different domains, including:
Virtual Assistants: AI agents like Siri, Alexa, and Google Assistant interact with users, understand natural language, and perform tasks such as answering questions, setting reminders, and controlling smart home devices.
Chatbots: AI agents used in customer service and support systems to interact with users, answer questions, provide assistance, and handle simple tasks.

Recommendation Systems: AI agents analyze user behavior and preferences to provide personalized recommendations for products, movies, music, and content.

AI agents can be simple or complex, depending on the task they are designed to perform. They can also range from rule-based systems to advanced machine learning models capable of learning from data and improving their performance over time.

AI agents can perform a wide range of tasks across various domains, including:
Natural Language Processing (NLP): AI agents can translate text or speech from one language to another (Language Translation), analyze text data to determine the sentiment expressed (Sentiment Analysis), and identify and classify entities mentioned in text data, such as names of people, organizations, or locations (Named Entity Recognition (NER));
Computer Vision and Object Detection: AI agents can identify and locate objects within images or videos;
Image Classification: AI agents can classify images into predefined categories;
Facial Recognition: AI agents can recognize and identify human faces in images or videos;
Data Analysis and Predictive Modeling: AI agents can analyze historical data to make predictions about future events or trends (Predictive Analytics), identify unusual patterns or outliers in data (Anomaly Detection) and forecast future values based on historical time series data (Time Series Forecasting);
Healthcare: AI agents can assist healthcare professionals in diagnosing diseases and medical conditions based on patient data, and can analyze patient data to recommend personalized treatment plans;
Finance: AI agents can analyze financial data and facilitate transactions, identify fraudulent activities by analyzing financial transactions and assess the creditworthiness of individuals or businesses based on their financial history;
Virtual Reality (VR) and Augmented Reality (AR): AI agents can enhance user experiences in VR and AR applications by providing intelligent interactions and personalized content;
Cybersecurity: Intrusion Detection: AI agents can detect and respond to security threats in computer networks;
Malware Detection: AI agents can identify and neutralize malicious software; and
Content Creation: AI agents can generate text, images, music, and other forms of content automatically.

AI agents can be linked to NFTs in several ways:
Ownership and Authentication: NFTs can be used to prove ownership and authenticate AI agents. Each AI agent can be represented by a unique NFT, and ownership of the agent can be transferred via the NFT;
Training Data and Model: NFTs and their associated metadata can represent the training data used to train the AI agent or the model itself. This can ensure the transparency of the AI's capabilities and its training data;
Royalties and Intellectual Property Rights: NFTs can also be used to manage royalties and intellectual property rights associated with AI agents. Creators can receive royalties whenever their AI agents are used;
Marketplaces and Trading: NFT marketplaces can facilitate the trading of AI agents. Creators can sell, buy, or exchange AI agents using NFTs, with the ownership of the AI agent being transferred along with the NFT;
Customization and Upgrades: NFTs can represent unique features, attributes, or upgrades of AI agents. For example, owners can share or grant temporary access to NFTs to advertisers or approved third parties to represent these features and allow them to apply AI agents to customizing or personalizing communication according to preferences; and
Provenance and History: NFTs can store the provenance and history of an AI agent, including its previous owners, usage history, and any modifications made to it.

By linking AI agents to NFTs, creators can ensure ownership, authenticity, and traceability, while also providing a platform for trading, sharing, accessing, customizing, and monetizing data accessible by AI agents.

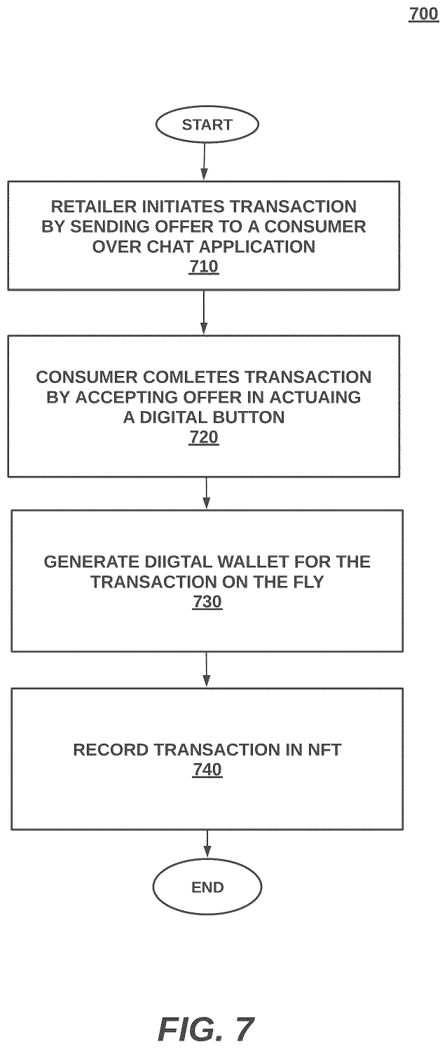

### III. Methods for Chat App NFT Transactions (FIGS. 7-8)

FIG. 7 is a high-level flow diagram illustrating a method 700 for conducting NFT transactions over chat applications, according to one embodiment. At step 710, a retailer initiates a transaction by sending an offer to a consumer over a chat application. At step 720, the consumer completes the transaction by accepting the offer in actuating a digital button, biometrics, facial recognition, passwords or other common techniques. At step 730, a digital wallet is generated via NFT engine 110. At step 740, the transaction is recorded in an NFT.

FIG. 8 is a more detailed flow diagram illustrating a method 800 for conducting NFT transactions over chat applications, according to one embodiment. At step 810, a chat private key/wallet address pair associated with a specific renter is created to interact with the system, wherein the chat private key/wallet address pair is associated with a specific blockchain

At step 820, an entity private key/wallet address pair associated with a specific user is created to interact with the smart contract and store at least a portion of the chat data associated with the specific chat on the blockchain.

At 830, a smart contract for chat data associated with a relationship between a specific chat in a chat history database is created.

At step 840, a new NFT in a series on the specific blockchain is generated according to new chat data using the smart contract and authorized by the entity private key/wallet key pair of the specific chat to activate the chat history.

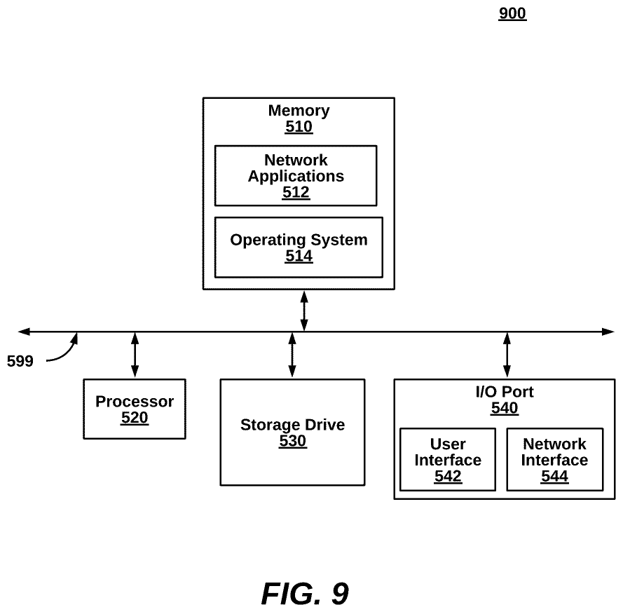

### III. Computing Device for Chat App NFT Transactions (FIG. 9)

FIG. 9 is a block diagram illustrating a computing device 900 for use in the system 100 of FIG. 1, according to one embodiment. The computing device 700 is a non-limiting example device for implementing each of the components of the system 100, including NFT engine 110, chat transaction module 120, consumer device 130 and retailer device 140. Additionally, the computing device 700 is merely an example implementation itself, since the system 100 can also be fully or partially implemented with laptop computers, tablet computers, smart cell phones, Internet access applications, and the like.

The computing device 700 of the present embodiment, includes a memory 510, a processor 520, a hard drive 530, and an I/O port 540. Each of the components is coupled for electronic communication via a bus 599. Communication can be digital and/or analog and use any suitable protocol.

The memory 510 further comprises network access applications 512 and an operating system 514. Network access applications can include 512 a web browser, a mobile access application, an access application that uses networking, a remote access application executing locally, a network protocol access application, a network management access application, a network routing access application, or the like.

The operating system 514 can be one of the Microsoft Windows® family of operating systems (e.g., Windows 98, 98, Me, Windows NT, Windows 2000, Windows XP, Windows XP x84 Edition, Windows Vista, Windows CE, Windows Mobile, Windows 7-11), Linux, HP-UX, UNIX, Sun OS, Solaris, Mac OS X, Alpha OS, AIX, IRIX32, or IRIX84. Other operating systems may be used. Microsoft Windows is a trademark of Microsoft Corporation.

The processor 520 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 520 can be single core, multiple core, or include more than one processing element. The processor 520 can be disposed on silicon or any other suitable material. The processor 520 can receive and execute instructions and data stored in the memory 510 or the hard drive 530.

The storage device 530 can be any non-volatile type of storage such as a magnetic disc, EPROM, Flash, or the like. The storage device 530 stores code and data for access applications.

The I/O port 540 further comprises a user interface 542 and a network interface 544. The user interface 542 can output to a display device and receive input from, for example, a keyboard. The network interface 544 connects to a medium such as Ethernet or Wi-Fi for data input and output. In one embodiment, the network interface 544 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, Javascript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11 g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

Various cloud vendors provide platforms and services that support the development and deployment of AI agents. These cloud vendors are continuously adding support features, improved capability and services in support of their cloud offerings. Some of the major providers include Amazon Web Services (AWS) (Amazon Lex: A service for building conversational interfaces into any application using voice and text; Amazon Polly: A service that turns text into lifelike speech, allowing users to create applications that talk; Amazon Rekognition: A service for adding image and video analysis to applications; Amazon Comprehend: A natural language processing (NLP) service for understanding the content of text documents; Amazon SageMaker: A fully managed service that provides developers and data scientists with the ability to build, train, and deploy machine learning (ML) models); Microsoft Azure (Azure Bot Service: A service that enables you to build intelligent, enterprise-grade bots that help enrich the customer experience while reducing costs; Azure Cognitive Services: A set of APIs, SDKs, and services available to help developers build intelligent applications without having direct AI or data science skills; Azure Machine Learning: A cloud-based environment that a user can use to train, deploy, automate, and manage machine learning models0; Google Cloud Platform (GCP) (Google Dialogflow: A natural language understanding platform that makes it easy to design and integrate a conversational user interface into mobile app, web application, device, bot, interactive voice response system, and more; Google Cloud Speech-to-Text and Text-to-Speech: APIs for converting audio to text and vice versa; Google Cloud Vision API: Enables developers to understand the content of an image by encapsulating powerful machine learning models in an easy-to-use REST API; and Cloud Natural Language API: Provides natural language understanding technologies to developers).

These cloud vendors offer a wide range of AI and machine learning tools and services, enabling developers to create sophisticated AI agents, chatbots and virtual assistants.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

We claim:

1. A computer-implemented method in a system, on a data communication network, for providing immutable chat session history transactions within a non-fungible cryptographic token (NFT) based chat session certificate, the method comprising:
creating a user private key/wallet address pair associated with a specific user to interact with the system, wherein the user private key/wallet address pair is associated with a specific blockchain;
creating an entity private key/wallet address pair associated with a specific chat service provider to interact with the smart contract and store at least a portion of the chat data associated with the specific chat on the blockchain;
creating a smart contract for chat data associated with a relationship between a specific entity in a chat history database;
generating a new NFT in a series on the specific blockchain according to new chat data using the smart contract and authorized by the entity private key/wallet key pair; and
sending the NFT to the user private key/wallet address pair associated with the specific user.

2. A non-transitory computer-readable medium in a chat session history system, on a data communication network, storing code that when executed, performs a method for capturing rental history using a non-fungible cryptographic token (NFT) based rental certificate, the method comprising:
creating a user private key/wallet address pair associated with a specific user to interact with the system, wherein the user private key/wallet address pair is associated with a specific blockchain;
creating an entity private key/wallet address pair associated with a specific chat service provider to interact with the smart contract and store at least a portion of the chat data associated with the specific chat on the blockchain;
creating a smart contract for chat data associated with a relationship between a specific chat in a chat history database;
generating a new NFT in a series on the specific blockchain according to new chat data using the smart contract and authorized by the entity private key/wallet key pair; and
sending the NFT to the user private key/wallet address pair associated with the specific user.

3. A chat session history system, on a data communication network, for capturing chat session history using a non-fungible cryptographic token (NFT) based chat session certificate, the chat session history system comprising:
a processor;
a network interface communicatively coupled to the processor and to a data communication network; and
a memory, communicatively coupled to the processor and storing:
a first module to create a user private key/wallet address pair associated with a specific user to interact with the system, wherein the user private key/wallet address pair is associated with a specific blockchain;
a second module to create an entity private key/wallet address pair associated with a specific chat service provider to interact with the smart contract and store at least a portion of the chat data associated with the specific chat on the blockchain;
a third module to create a smart contract for chat data associated with a relationship between a specific chat in a chat history database;
a fourth module to generate a new NFT in a series on the specific blockchain according to new chat data using the smart contract and authorized by the entity private key/wallet key pair; and
a fifth module to send the NFT to the user private key/wallet address pair associated with the specific user.
